(19) United States
(12) Patent Application Publication
(10) Pub. No.: US 2025/0038918 A1
(43) Pub. Date: Jan. 30, 2025

(54) INFORMATION PROCESSING METHOD, COMMUNICATION DEVICE, AND STORAGE MEDIUM

(71) Applicant: Beijing Xiaomi Mobile Software Co., Ltd., Beijing (CN)

(72) Inventors: Qin MU, Beijing (CN); Xuemei QIAO, Beijing (CN)

(73) Assignee: Beijing Xiaomi Mobile Software Co., Ltd., Beijing (CN)

(21) Appl. No.: 18/716,882

(22) PCT Filed: Dec. 6, 2021
(86) PCT No.: PCT/CN2021/135876

§ 371 Date: Jun. 5, 2024

(51) Int. Cl. H04L 5/00; H04W 72/04

(52) U.S. Cl. CPC H04L 5/0051; H04W 72/04

(57) ABSTRACT

An information processing method, a communication device, and a storage medium. The information processing method is performed by a UE, and includes: according to a number of AI models corresponding to a DMRS pattern, using the AI model corresponding to the DMRS pattern to perform channel estimation.

### CROSS REFERENCE TO RELATED APPLICATIONS

The present application is a U.S. National Stage of International Application No. PCT/CN2021/135876 filed on Dec. 6, 2021, the content of which is incorporated herein by reference in its entirety.

### TECHNICAL FIELD

The present disclosure relates to, but is not limited to, the field of communication technology, and in particular relates to information processing methods, a communication device, and a storage medium.

### BACKGROUND

For a new radio (NR) system facing complex and diverse application scenarios as well as richer service types, a design of a demodulation reference signal (DMRS) needs to take flexibility of configuration of various system parameters into full consideration. Therefore, there will be many different types of DMRS in the NR system.

With a further increase of a number of antennas at a transceiver end in a beyond 5th generation mobile communication system (B5G) or a 6th generation mobile communication system (6G), the heavy use of multiple input multiple output (MIMO) increases difficulty of channel estimation. Many studies have considered introducing artificial intelligence (AI) methods to realize the channel estimation, but in scenarios where a channel environment and mobility of user equipment (UE) show a high degree of variability, using one same AI model to realize the channel estimation is obviously unable to satisfy demands.

### SUMMARY

Embodiments of the present disclosure provide information processing methods and apparatuses, a communication device, and a storage medium.

According to a first aspect of the present disclosure, there is provided an information processing method, performed by a UE, the information processing method including: according to a quantity of one or more AI models corresponding to a DMRS pattern, using the AI model corresponding to the DMRS pattern to perform channel estimation.

According to a second aspect of the present disclosure, there is provided an information processing method, performed by a base station, the information processing method including: sending configuration information for indicating a quantity of one or more AI models corresponding to a DMRS pattern, where the quantity of one or more AI models corresponding to the DMRS pattern is for instructing a UE to determine an AI model to perform channel estimation according to the quantity of one or more AI models corresponding to the DMRS pattern.

According to a third aspect of the present disclosure, there is provided an information processing method, performed by a base station, the information processing method including: receiving first recommended information; where the first recommended information indicates a DMRS pattern used by a UE, or the first recommended information indicates the DMRS pattern used by the UE and an AI model required by the UE; where the AI model is for the UE to perform channel estimation; determining, based on the first recommended information, model information of the AI model corresponding to the DMRS pattern required by the UE; and sending the model information.

According to a fourth aspect of the present disclosure, there is provided a communication device, including: a processor; and a memory for storing executable instructions for the processor. Where the processor is configured for executing the executable instructions to implement the information processing method of any embodiment of the present disclosure.

According to a fifth aspect of the present disclosure, there is provided a non-transitory computer storage medium having a computer executable program stored thereon, where the executable program is executed by a processor to implement the information processing method of any embodiment of the present disclosure.

It should be understood that the general description above and the detailed descriptions that follow are for examples and explanations only and do not limit the embodiments of the present disclosure.

### BRIEF DESCRIPTION OF DRAWINGS

FIG. 1 is a schematic structure diagram of a wireless communication system.

FIG. 2 is a flowchart illustrating an information processing method according to an example of the present disclosure.

FIG. 3 is a flowchart illustrating an information processing method according to an example of the present disclosure.

FIG. 4 is a flowchart illustrating an information processing method according to an example of the present disclosure.

FIG. 5 is a flowchart illustrating an information processing method according to an example of the present disclosure.

FIG. 6 is a flowchart illustrating an information processing method according to an example of the present disclosure.

FIG. 7 is a flowchart illustrating an information processing method according to an example of the present disclosure.

FIG. 8 is a flowchart illustrating an information processing method according to an example of the present disclosure.

FIG. 9 is a flowchart illustrating an information processing method according to an example of the present disclosure.

FIG. 10 is a flowchart illustrating an information processing method according to an example of the present disclosure.

FIG. 11 is a block diagram illustrating an information processing apparatus according to an example of the present disclosure.

FIG. 12 is a block diagram illustrating an information processing apparatus according to an example of the present disclosure.

FIG. 13 is a block diagram illustrating an information processing apparatus according to an example of the present disclosure.

FIG. 14 is a block diagram illustrating a UE according to an example.

FIG. 15 is a block diagram illustrating a base station according to an example.

FIG. 16 is a flowchart illustrating an information processing method according to an example of the present disclosure.

FIG. 17 is a flowchart illustrating an information processing method according to an example of the present disclosure.

FIG. 18 is a flowchart illustrating an information processing method according to an example of the present disclosure.

FIG. 19 is a flowchart illustrating an information processing method according to an example of the present disclosure.

FIG. 20 is a flowchart illustrating an information processing method according to an example of the present disclosure.

FIG. 21 is a flowchart illustrating an information processing method according to an example of the present disclosure.

### DETAILED DESCRIPTION

Embodiments will be described herein in detail, examples of which are represented in the accompanying drawings. When the following descriptions involve the drawings, like numerals in different drawings represent like or similar elements unless stated otherwise. Implementations described in the following examples do not represent all implementations consistent with the embodiments of the present disclosure. Instead, they are merely examples of device and methods consistent with certain aspects of the embodiments of the present disclosure, as detailed in the appended claims.

Terms used in the present disclosure are for the purpose of describing particular examples only and are not intended to limit the embodiments of the present disclosure. As used in the embodiments of the present disclosure and the appended claims, the singular forms “an” and “the” are intended to include the plural forms as well, unless the context clearly indicates otherwise. It should also be understood that the term “and/or” as used herein refers to and includes any and all possible combinations of one or more of the associated listed items.

It shall be understood that, although the terms “first,” “second,” “third,” and the like may be used herein to describe various information, the information should not be limited by these terms. These terms are only used to distinguish one category of information from another. For example, without departing from the scope of the embodiments of the present disclosure, first information may be referred as second information; and similarly, second information may also be referred as first information. Depending on the context, the term “if” may be interpreted as “when” or “upon” or “in response to determining”.

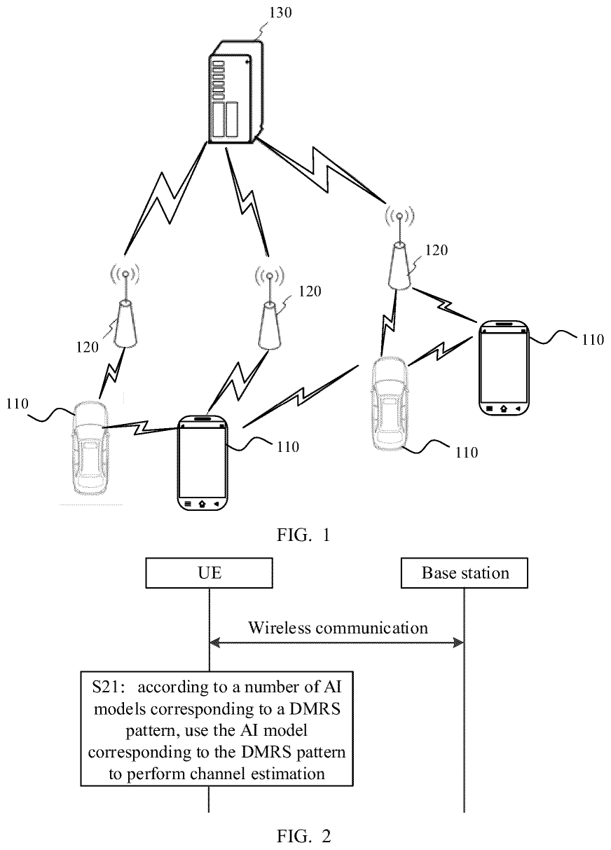

Referring to FIG. 1, FIG. 1 is a schematic structure diagram of a wireless communication system provided by an embodiment of the present disclosure. As shown in FIG. 1, the wireless communication system is a communication system based on a cellular mobile communication technology. The wireless communication system may include: a plurality of user equipment 110 and a plurality of base stations 120.

The user equipment 110 may refer to a device that provides voice and/or data connectivity to a user. The user equipment 110 may communicate with one or more core networks via a Radio Access Network (RAN). The user equipment 110 may be an Internet of Things (IoT) user equipment, such as a sensor device, a cell phone (or referred to as a “cellular” phone), and a computer having an IoT user equipment. The user equipment 110, for example, may be a stationary, portable, pocket-sized, hand-held, computer-built, or vehicle-mounted device, e.g., a Station (STA), a subscriber unit, a subscriber station, a mobile station, a mobile, a remote station, an access point, a remote terminal, an access terminal, a user terminal, a user agent, a user device, or a user equipment. In another example, the user equipment 110 may be an unmanned aerial vehicle device. In another example, the user equipment 110 may be an on-board device, for example, a traveling computer with wireless communication capabilities, or a wireless user equipment with an external traveling computer. In another example, the user equipment 110 may be a roadside device, such as a street light, a signal light, or other roadside devices with wireless communication capabilities.

The base station 120 may be a network-side device in a wireless communication system. The wireless communication system may be a 4th generation mobile communication (4G) system, also known as a Long Term Evolution (LTE) system. In another example, the wireless communication system may be a 5G system, also referred to as a new radio (NR) system or a 5G NR system. In another example, the wireless communication system may be a next generation system of the 5G system. An access network in the 5G system may be referred to as a New Generation-Radio Access Network (NG-RAN).

The base station 120 may be an evolved base station (eNB) in the 4G system. In another example, the base station 120 may be a base station employing a central distributed architecture (gNB) in the 5G system. The base station 120 with the central distributed architecture usually includes a central unit (CU) and at least two distributed units (DUs). The central unit is provided with protocol stacks for a Packet Data Convergence Protocol (PDCP) layer, a Radio Link Control (RLC) layer, and a Medium Access Control (MAC) layer therein. And the distributed unit is provided with a protocol stack for a Physical (PHY) layer therein. The embodiments of the present disclosure do not limit the specific implementation of the base station 120.

The base station 120 may establish a wireless connection with the user equipment 110 through a radio air interface. In different implementations, the radio air interface is a 4G specification based radio air interface. In another example, the radio interface is a 5G specification based radio air interface. For example, the radio air interface is a new radio air interface. In another example, the radio air interface may be a radio air interface based on a next generation mobile communication network technology specification of 5G.

In some embodiments, the user equipment 110 may also establish End-to-End (E2E) connections with one another, e.g., scenes of Vehicle to Vehicle (V2C) communication, Vehicle to Infrastructure (V2I) communication, Vehicle to Pedestrian (V2P) communication and the like in Vehicle to Everything (V2X).

Here, the previously described user equipment may be considered to be terminals of the following embodiment.

In some embodiments, the wireless communication system may further include a network management device 130.

Several base stations 120 are connected with the network management device 130 respectively. The network management device 130 may be a core network device in the wireless communication system. For example, the network management device 130 may be a Mobility Management Entity (MME) in an Evolved Packet Core (EPC). In another example, the network management device may be another core network device, e.g., a Serving GateWay (SGW), a Public Data Network GateWay (PGW), a Policy and Charging Rules Function (PCRF) or a Home Subscriber Server (HSS). An implementation form of the network management device 130 is not limited in the embodiment of the disclosure.

In order to facilitate the understanding of those skilled in the art, the present disclosure embodiments enumerate a plurality of embodiments to provide a clear description of the technical solutions of the present disclosure embodiments. Of course, a person skilled in the art may understand that the plurality of embodiments provided by the embodiments of the present disclosure may be performed alone or combined with the methods of the other embodiments of the embodiments of the present disclosure, or may be performed in conjunction with some of the methods of other related technologies with or without combined with the methods of the other embodiments of the embodiments of the present disclosure, which is not limited by the embodiments of the present disclosure.

An embodiment of the present disclosure provides an information processing method, performed by a UE, the information processing method including whether to use an AI model for channel estimation is determined.

In some possible implementations, the method may include: determining whether to use the AI model for channel estimation according to AI indication information received from a network device.

Here, the UE may be various terminals. For example, the UE may be, but is not limited to, a cell phone, a computer, a server, a wearable device, a game control platform, or a multimedia device.

Here, the network device includes an access network device or a core network device. The access network device may be a base station or the like. The base station may be various types of base stations, for example, a 2G base station, a 3G base station, a 4G base station, a 5G base station, or other evolved base stations. The core network device may be various physical entities or logical entities, for example, may have various Network Functions (NFs), such as an Access and Mobility Management Function (AMF).

In some possible application scenarios, input and output dimensions of the AI model for channel estimation are different when DMRS patterns configured by the base station and situations of carrying DMRS are different, and complexity of the AI model to be employed is also different for different channel environments. Thus it is possible to determine whether or not to enable an AI method depending on a specific situation. In some possible implementations, the UE may determine whether to employ the AI model for channel estimation based on indication information received from a network-side. For example, an AI_indicator may be included in the indication information to indicate whether to enable the AI method. For example, the AI_indicator=0 indicates that the AI method is not enabled for channel estimation, and the AI indicator=1 indicates that the AI method is enabled for channel estimation.

In some possible application scenarios, the UE may determine which AI model will be used for channel estimation based on the indication information received from the network-side. For example, the indication information may include a Model_indictor to indicate a selected model for channel estimation.

In this way, it is possible to accurately determine, based on the AI indication information, whether or not to perform channel estimation based on the AI model.

As shown in FIG. 2, an embodiment of the present disclosure provides an information processing method, performed by a UE, the information processing method including step S21.

Step S21: according to a number of AI models corresponding to a DMRS pattern, the AI model corresponding to the DMRS pattern is used to perform channel estimation.

Here, the UE may be various terminals. For example, the UE may be, but is not limited to, a cell phone, a computer, a server, a wearable device, a game control platform, or a multimedia device.

Here, the DMRS pattern includes time-frequency mapping resources of the DMRS within a resource block (RB) or resource element (RE). For example, one DMRS pattern includes: the DMRS being carried on the 4th and 8th symbols of one RB. As another example, one DMRS pattern includes: the DMRS being carried on the 4th and 8th symbols on the 1st and 2nd subcarriers of one RB.

Here, the number of the AI models corresponding to one DMRS pattern may be one or more.

In an embodiment, the UE may determine that the number of the AI models corresponding to the DMRS pattern is one or more according to a protocol agreement.

In another embodiment, the UE may determine that the number of the AI models corresponding to the DMRS pattern is one or more, based on model deployment information of the UE. For example, the UE receives the model deployment information of the UE sent by the network device. The model deployment information includes: at least one correspondence between DMRS pattern and AI model. The correspondence includes: a correspondence between one DMRS pattern and one AI model, and/or a correspondence between one DMRS pattern and a plurality of AI models.

Here, the network device includes an access network device or a core network device. The access network device may be a base station or the like. The base station may be various types of base stations, for example, a 2G base station, a 3G base station, a 4G base station, a 5G base station, or other evolved base stations. The core network device may be various physical entities or logical entities, for example, various NFs such as an AMF.

When the UE receives information sent by the core network device, it may be: the UE receives the information sent by the core network device which is forwarded by the base station.

In yet another embodiment, the UE may determine that the number of the AI models corresponding to the DMRS pattern is one or more, based on configuration information sent by the base station. For example, the UE receives the configuration information indicating the number of the AI models corresponding to the DMRS pattern sent by the base station. In response to determining that the configuration information indicates that the DMRS pattern corresponds to one AI model, the UE determines that the DMRS pattern corresponds to one AI model. Or, in response to determining that the configuration information indicates that the DMRS pattern corresponds to a plurality of AI models, the UE determines that the DMRS pattern corresponds to a plurality of AI models.

In this way, it may be determined that the number of the AI models corresponding to the DMRS pattern is one or more based on a variety of ways, such as a protocol agreement, model deployment information in the UE, or configuration of the base station.

In embodiments of the present disclosure, the UE adopts the AI model corresponding to the DMRS pattern for channel estimation according to the number of the AI models corresponding to the DMRS pattern. In this way, on the one hand, there is no need to use the same AI model for channel estimation for all DMRS patterns, and appropriate AI models for different DMRS patterns can be used for channel estimation, thereby improving applicability of the AI method in channel estimation and making the AI method better adapted to a variety of channel environments. On the other hand, based on the number of the AI models corresponding to the DMRS pattern, it is possible to accurately determine the AI model corresponding to the DMRS pattern and used for performing channel estimation, thus improving accuracy of determining the AI model as well as efficiency and performance of channel estimation.

The step S21 may include one of the following: in response to the number of the AI models corresponding to the DMRS pattern is one, using the AI model corresponding to the DMRS pattern to perform channel estimation; or in response to the number of the AI models corresponding to the DMRS pattern is a plurality, determining one AI model from the plurality of AI models corresponding to the DMRS pattern to perform channel estimation.

That in response to the number of the AI models corresponding to the DMRS pattern is the plurality, determining one AI model from the plurality of AI models corresponding to the DMRS pattern to perform channel estimation, includes one of the following: i) in response to the number of the AI models corresponding to the DMRS pattern is the plurality, based on AI model indication information, determining one AI model from the plurality of AI models corresponding to the DMRS pattern to perform channel estimation; ii) in response to the number of the AI models corresponding to the DMRS pattern is the plurality, determining any one of the plurality of AI models for channel estimation; and iii) in response to the number of the AI models corresponding to the DMRS pattern is the plurality, selecting one AI model matching one of a moving speed of the UE, channel quality, computational capability of the UE, and storage capability of the UE from the plurality of AI models.

In some embodiments of the present disclosure, the information processing method performed by the UE may include: in response to the number of the AI models corresponding to the DMRS pattern is one, using the AI model corresponding to the DMRS pattern to perform channel estimation; or in response to the number of the AI models corresponding to the DMRS pattern is the plurality, based on AI model indication information, determining one AI model from the plurality of AI models to perform channel estimation.

The AI model indication information may be sent by the base station. For example, the UE receives configuration information sent by the base station, where the configuration information includes: the AI model indication information instructing the UE to determine an AI model for channel estimation from the AI models corresponding to the DMRS pattern; and the UE obtains the AI model indication information based on the configuration information.

In an example, in response to determining that the number of the AI models corresponding to the DMRS pattern is one, the UE determines using the AI model corresponding to the DMRS pattern to perform channel estimation.

In an example, in response to determining that the number of the AI models corresponding to the DMRS pattern is a plurality, the UE performs channel estimation based on one AI model, among the plurality of AI models corresponding to the DMRS pattern, indicated by the AI model indication information. For example, the plurality of AI models corresponding to the DMRS pattern are AI model 1, AI model 2, and AI model 3. If the AI model indication information received by the UE indicates the AI model 3, the UE performs channel estimation based on the AI model 3.

In this way, in embodiments of the present disclosure, the UE may also receive the AI model indication information configured by the base station to accurately indicate the one AI model to be used by the UE when the number of the AI models corresponding to the DMRS pattern is a plurality. In this way, the UE may be enabled to determine a suitable AI model for channel estimation. In another example, when the number of the AI models corresponding to the DMRS pattern is one, there is no need of AI model indication information to indicate the AI model, and the UE may directly perform channel estimation based on the AI model corresponding to the DMRS pattern.

In some embodiments of the present disclosure, the information processing method performed by the UE may include: in response to the number of the AI models corresponding to the DMRS pattern is a plurality, determining any one of the plurality of AI models for channel estimation.

In this way, in embodiments of the present disclosure, in response to the number of the AI models corresponding to the DMRS pattern is a plurality, it is also possible to arbitrarily select one AI model from the plurality of AI models for channel estimation. In another example, it is also possible to select appropriate AI models for different DMRS patterns for channel estimation, thereby improving applicability of the AI method in channel estimation and making the AI method better adapted to a variety of channel environments, so as to improve efficiency and performance of channel estimation to a certain extent.

In some embodiments of the present disclosure, the information processing method performed by the UE may include: in response to the number of the AI models corresponding to the DMRS pattern is a plurality, selecting one AI model from the plurality of AI models. Where the selected AI model matches one of a moving speed of the UE, channel quality, computational capability of the UE, and storage capability of the UE.

In an example, in response to the number of the AI models corresponding to the DMRS pattern is a plurality, the moving speed of the UE is positively correlated with a size of an input dimension of the AI model selected by the UE. For example, if the moving speed of the UE is relatively fast, the UE may select an AI model with a relatively large input dimension from the plurality of AI models for channel estimation; and if the moving speed of the UE is relatively slow, the UE may select an AI model with a relatively small input dimension from the plurality of AI models for channel estimation.

In an example, in response to the number of the AI models corresponding to the DMRS pattern is a plurality, quality of channel environment indicated by the channel quality is negatively correlated with the size of the input dimension of the AI model selected by the UE. For example, if the channel environment in which the UE is located is relatively bad, the UE may select an AI model with a relatively large input dimension from the plurality of AI models for channel estimation; and if the channel environment in which the UE is located is relatively good, the UE may select an AI model with a relatively small input dimension from the plurality of AI models for channel estimation.

In an example, in response to the number of the AI models corresponding to the DMRS pattern is a plurality, the computational power of the UE is positively correlated with the size of the input dimension of the AI model selected by the UE. For example, if the computational power of the UE is relatively strong, the UE may select an AI model with a relatively large input dimension from the plurality of AI models for channel estimation; and if the computational power of the UE is relatively weak, the UE may select an AI model with a relatively small input dimension from the plurality of AI models for channel estimation.

In an example, in response to the number of the AI models corresponding to the DMRS pattern is a plurality, the computational power of the UE is positively correlated with the size of the input dimension of the AI model selected by the UE. For example, if the computational power of the UE is relatively strong, the UE may select an AI model with a relatively large input dimension from the plurality of AI models for channel estimation; and if the computational power of the UE is relatively weak, the UE may select an AI model with a relatively small input dimension from the plurality of AI models for channel estimation.

In an example, in response to the number of the AI models corresponding to the DMRS pattern is a plurality, the storage capacity of the UE is positively correlated with the size of the input dimension of the AI model selected by the UE. For example, if the storage capacity of the UE is relatively large, the UE may select an AI model with a relatively large input dimension from the plurality of AI models for channel estimation; and if the computing capacity of the UE is relatively small, the UE may select an AI model with a relatively small input dimension from the plurality of AI models for channel estimation.

In this way, in embodiments of the present disclosure, if the UE does not obtain the AI model indication information, the UE may also accurately determine one AI model for channel estimation from the plurality of AI models corresponding to the DMRS pattern based on at least one of the moving speed of the UE, the quality of the channel in which the UE is located, the computational power of the UE, and the storage capacity of the UE. In this way, the AI model matching the capability of the UE can be selected, and the efficiency and performance of the channel estimation can also be improved.

It is to be noted that a person skilled in the art may understand that the methods provided by the embodiments of the present disclosure may be performed alone or in conjunction with some of the methods in the embodiments of the present disclosure or some of the methods in the related art.

In some embodiments (not shown), before step S21, the method further includes: determining the DMRS pattern; and/or determining whether to use the AI model corresponding to the DMRS pattern for channel estimation.

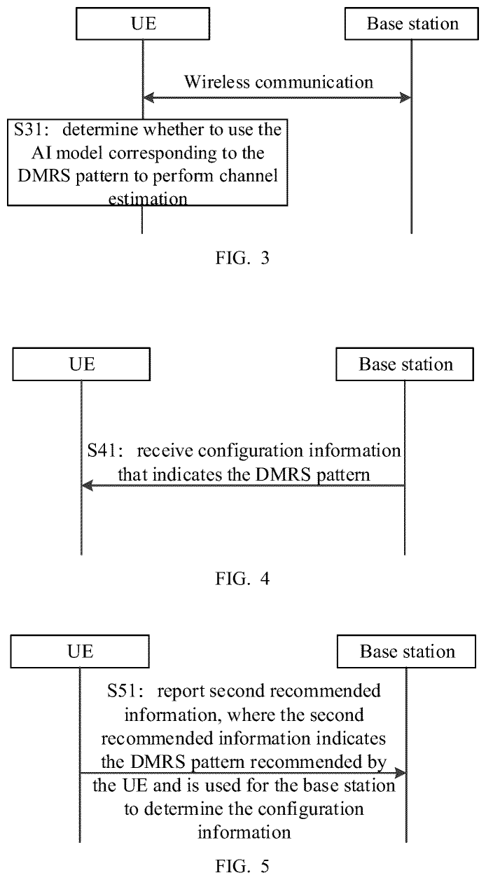

As shown in FIG. 3, an embodiment of the present disclosure provides an information processing method, performed by the UE, and including step S31.

Step S31: whether to use the AI model corresponding to the DMRS pattern for channel estimation is determined.

In some embodiments of the present disclosure, the DMRS pattern is the DMRS pattern in step S21.

In some possible implementations, the method may include: determining whether to use the AI model for channel estimation based on indication information received from the network device.

In some possible application scenarios, input and output dimensions of the AI model for channel estimation are different when DMRS patterns configured by the base station and situations of carrying DRMRS are different, and complexity of the AI model to be employed is also different for different channel environments. Thus it is possible to determine whether or not to enable an AI method depending on a specific situation. In some possible implementations, the UE may determine whether to employ the AI model for channel estimation based on indication information received from a network-side. For example, an AI indicator may be included in the indication information to indicate whether to enable the AI method. For example, the AI_indicator=0 indicates that the AI method is not enabled for channel estimation, and the AI indicator=1 indicates that the AI method is enabled for channel estimation.

In some possible application scenarios, the UE may determine which AI model will be used for channel estimation based on the AI indication information received from the network-side. For example, the AI indication information may include a Model_indictor to indicate a selected model for channel estimation.

In some embodiments of the present disclosure, the information processing method performed by the UE may include: determining the DMRS pattern.

Determining the DMRS pattern may be, but is not limited to: the UE receiving the configuration information that indicates the DMRS pattern from the base station, and/or, the UE determining the DMRS pattern.

The step S31 may be: determining to use the AI model corresponding to the DMRS pattern for channel estimation; or, determining not to use the AI model corresponding to the DMRS pattern for channel estimation.

In embodiments of the present disclosure, the DMRS pattern may be determined by the UE and it may be determined whether the AI model corresponding to the DMRS pattern is adopted for channel estimation. In this way, there is no need to use the same AI model for channel estimation for all DMRS patterns, and appropriate AI models for different DMRS patterns can be used for channel estimation, thereby improving applicability of the AI method in channel estimation and making the AI method better adapted to a variety of channel environments, so as to improve the efficiency and performance of channel estimation.

It is to be noted that a person skilled in the art may understand that the methods provided by the embodiments of the present disclosure may be performed alone or in conjunction with some of the methods in the embodiments of the present disclosure or some of the methods in the related art.

Determining the DMRS pattern may be: receiving the configuration information that indicates the DMRS pattern.

As shown in FIG. 4, an embodiment of the present disclosure provides an information processing method, performed by the UE, and including step S41.

Step S41: configuration information that indicates the DMRS pattern is received.

The step S41 may be: receiving the configuration information that indicates the DMRS pattern sent by the base station.

This configuration information includes the AI indication information indicating whether to enable the AI model for channel estimation.

In an example, the UE receives the configuration information that indicates the DMRS pattern sent by the base station, and based on the DMRS pattern, the UE uses the AI model corresponding to the DMRS pattern to perform channel estimation.

In an example, the UE receives configuration information that indicates the DMRS pattern sent by the base station, where the configuration information further includes the AI indication information. The UE enables the AI model to perform channel estimation based on the AI indication information, and uses the AI model corresponding to the DMRS pattern for channel estimation.

In an example, the UE receives the configuration information that indicates the DMRS pattern sent by the base station, where the configuration information further includes AI indication information. The UE determines not to use the AI model for channel estimation based on the AI indication information indicating not to enable the AI model for channel estimation.

In this way, in embodiments of the present disclosure, the DMRS pattern to be used by the UE may be determined by the configuration information sent by the base station and received by the UE. Thus, a way of determining the DMRS pattern based on the configuration of the base station is provided. Moreover, in embodiments of the present disclosure, it is also possible to determine, based on the AI indication information configured by the base station, whether the UE performs channel estimation based on the AI model corresponding to the DMRS pattern. In this way, the DMRS pattern can be flexibly selected and whether or not to enable the AI model for channel estimation can be determined based on different network environments and requirements.

The configuration information includes the AI model indication information instructing the UE to determine an AI model for channel estimation from the AI models corresponding to the DMRS pattern.

The step S31 may be: in response to the number of the AI models corresponding to the DMRS pattern is one, using the AI model corresponding to the DMRS pattern to perform channel estimation; or in response to the number of the AI models corresponding to the DMRS pattern is a plurality, based on the AI model indication information, determining one AI model from the plurality of AI models corresponding to the DMRS pattern to perform channel estimation.

In an example, the DMRS pattern determined by the UE corresponds to a plurality of AI models. The UE receives the configuration information that indicates the DMRS pattern sent by the base station, where the configuration information includes: the AI model indication information. The UE performs channel estimation based on one AI model, among the plurality of AI models corresponding to the DMRS pattern, indicated by the AI model indication information. For example, the plurality of AI models corresponding to the DMRS pattern are AI model 1, AI model 2, and AI model 3. If the AI model indication information received by the UE indicates the AI model 3, the UE performs the channel estimation based on the AI model 3.

In an example, the DMRS pattern determined by the UE corresponds to a plurality of AI models. The UE receives the configuration information that indicates the DMRS pattern sent by the base station, where the configuration information includes: the AI indication information and the AI model indication information. In response to determining that the AI indication information instructs to enable the AI model to perform channel estimation, then the UE performs channel estimation based on one AI model, among the plurality of AI models, indicated by the AI model indication information.

In this way, in embodiments of the present disclosure, the UE may also receive the AI model indication information configured by the base station to accurately indicate the one AI model to be used by the UE when the number of the AI models corresponding to the DMRS pattern is a plurality. In this way, the UE may be enabled to determine a suitable AI model for channel estimation. In another example, in response to the number of the AI models corresponding to the DMRS pattern is one, there is no need of AI model indication information to indicate the AI model, and the UE may directly perform channel estimation based on the AI model corresponding to the DMRS pattern.

It is to be noted that a person skilled in the art may understand that the methods provided by the embodiments of the present disclosure may be performed alone or in conjunction with some of the methods in the embodiments of the present disclosure or some of the methods in the related art.

As shown in FIG. 5, an embodiment of the present disclosure provides an information processing method, performed by the UE, and including step S51.

Step S51: second recommended information is reported, where the second recommended information indicates the DMRS pattern recommended by the UE, and is used for the base station to determine the configuration information.

In some embodiments of the present disclosure, the configuration information may be the configuration information in the embodiments described herein.

The second recommended information is used for the base station to determine the configuration information including an indicated DMRS pattern. In an example, if the UE reports the second recommended information to the base station, the base station then determines the DMRS pattern to be used by the UE based on the DMRS pattern recommended by the second recommended information. Therefore, the second recommended information is used for the base station to determine the configuration information including the indicated DMRS pattern.

The DMRS pattern recommended by the second recommended information may be the same or different from the DMRS pattern indicated by the configuration information.

The second recommended information is used for the base station to determine the configuration information including the AI indication information. In an example, if the UE reports the second recommended information to the base station, the base station determines whether or not the UE enables the AI model for channel estimation based on the DMRS pattern recommended by the second recommended information. Therefore, the second recommended information is used for the base station to determine the configuration information including the AI indication information.

In the above example, if the base station determines that the UE enables the AI model for channel estimation, the second recommended information is used for the base station to determine the configuration information including the indicated DMRS pattern and the AI indication information.

The second recommended information is used for the base station to determine the configuration information including the AI model indication information. In an example, if the UE reports the second recommended information to the base station, the base station determines that the DMRS pattern used by the UE corresponds to a plurality of AI models based on the DMRS pattern recommended by the second recommended information. Then the second recommended information is used for the base station to determine the configuration information including the AI model indication information, or the configuration information including the indicated DMRS pattern and the AI model indication information.

In this way, in embodiments of the present disclosure, the second recommended information indicating the DMRS pattern recommended by the UE may be reported by the UE, such that the base station may determine, based on the report, whether the UE enables the AI model for channel estimation, and/or the DMRS pattern that the UE is required to use. And in response to determining that the DMRS pattern to be used by the UE corresponds to a plurality of AI models, the base station may also determine the configuration information including AI model indication information.

In some embodiments of the present disclosure, the information processing method performed by the UE may include: determining the DMRS pattern recommended by the UE based on at least one of mobility information, channel quality information, computational capability information, and storage capability information of the UE.

Here, the mobility information of the UE indicates the moving speed of the UE, which is positively correlated with density of the DMRS pattern. That is, the faster the moving speed of the UE is, the denser the determined DMRS pattern is; and the slower the moving speed of the UE is, the sparser the determined DMRS pattern is.

Here, the density of the DMRS pattern refers to a number of resource elements carrying the DMRS within a resource block. For example, the more resource elements carrying the DMRS within one resource block, the denser the DMRS pattern is; and the fewer resource elements carrying the DMRS within one resource block, the sparser the DMRS pattern is.

Here, the channel quality information indicates the quality of the channel environment, which is negatively correlated with the density of the DMRS pattern. That is, the worse the channel environment is, the denser the determined DMRS pattern is; and the better the channel environment is, the sparser the determined DMRS pattern is.

Here, the computational power indicated by the computational capability information of the UE is positively correlated with the density of the DMRS pattern. That is, the stronger the computing power of the UE is, the denser the determined DMRS pattern is; and the worse the computing power of the UE is, the sparser the determined DMRS pattern is. In an embodiment, the computing power may be represented by a magnitude of the arithmetic power.

Here, the storage capacity indicated by the storage capability information of the UE is positively correlated with the density of the DMRS pattern. That is, the larger the storage capacity of the UE is, the denser the determined DMRS pattern is; and the smaller the storage capacity of the UE is, the sparser the determined DMRS pattern is.

In this way, in the embodiments of the present disclosure, based on at least one of the moving speed of the UE indicated by the mobility information of the UE, the quality of the channel environment indicated by the channel quality information, the computational power indicated by the computational capability information of the UE, and the storage capacity indicated by the storage capability information of the UE, a recommended DMRS pattern of a suitable density may be determined. That is, it may be possible to determine accurately a recommended suitable DMRS pattern. In this way, the UE may report the recommended DMRS pattern to the base station, which is advantageous for the base station to determine the suitable DMRS pattern to be used by the UE based on the recommended DMRS pattern, etc.

It is to be noted that a person skilled in the art may understand that the methods provided by the embodiments of the present disclosure may be performed alone or in conjunction with some of the methods in the embodiments of the present disclosure or some of the methods in the related art.

Determining the DMRS pattern may be: determining the DMRS pattern based on at least one of the mobility information, the channel quality information, the computational capability information, and the storage capability information of the UE.

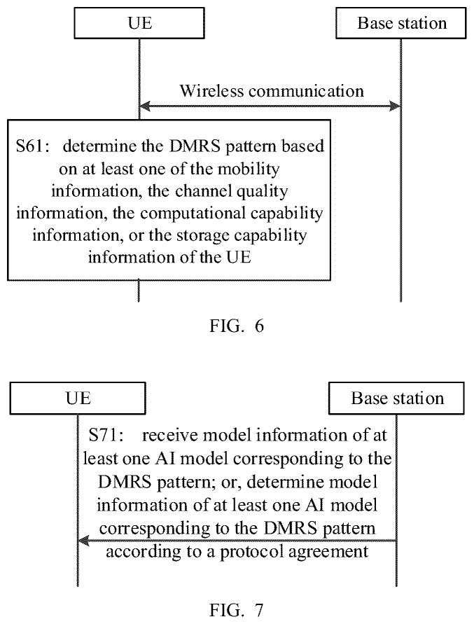

As shown in FIG. 6, an embodiment of the present disclosure provides an information processing method, performed by the UE, and including step S61.

Step S61: based on at least one of the mobility information, the channel quality information, the computational capability information, and the storage capability information of the UE, the DMRS pattern is determined.

In embodiments of the present disclosure, determining the DMRS pattern based on at least one of the mobility information, the channel quality information, the computational capability information, and the storage capability information of the UE in step S51 is similar to determining the DMRS pattern recommended by the UE based on at least one of the mobility information, the channel quality information, the computational capability information, and the storage capability information of the UE in the embodiments described herein. Therefore the method of step S51 will not be repeated herein.

In this way, in the embodiments of the present disclosure, the DMRS pattern to be used may be determined by the UE receiving one of the mobility information, the channel quality information, the computational capability information, and the storage capability information of the UE. In this way, the DMRS pattern may be selected according to the UE, realizing a flexible configuration method of the DMRS pattern.

It is to be noted that a person skilled in the art may understand that the methods provided by the embodiments of the present disclosure may be performed alone or in conjunction with some of the methods in the embodiments of the present disclosure or some of the methods in the related art.

As shown in FIG. 7, an embodiment of the present disclosure provides an information processing method, performed by the UE, and including step S71.

Step S71: model information of at least one AI model corresponding to the DMRS pattern is received; or, model information of at least one AI model corresponding to the DMRS pattern is determined according to a protocol agreement.

Receiving the model information of the at least one AI model corresponding to the DMRS pattern in this step S71 may include: receiving the model information of the at least one AI model corresponding to the DMRS pattern sent by the base station. Here, based on the model deployment information of the UE stored by the base station, it may be determined whether there is model information of the at least one AI model corresponding to the DMRS pattern in the UE. If there is no model information of the AI model corresponding to the DMRS pattern in the UE, the model information of the at least one AI model corresponding to the DMRS pattern is directly sent to the UE.

Receiving the model information of the at least one AI model corresponding to the DMRS pattern in this step S71 may include: in response to that there is no AI model corresponding to the DMRS pattern in the UE, the model information of the at least one AI model corresponding to the DMRS pattern is received.

There is no AI model corresponding to the DMRS pattern in the UE may be that: there is no AI model corresponding to the DMRS pattern in the UE; or, there is at least one AI model corresponding to the DMRS pattern in the UE, but none of the at least one AI model is an AI model indicated by the AI model indication information.

In some embodiments of the present disclosure, the information processing method performed by the UE may include: in response to there being no AI model corresponding to the DMRS pattern in the UE, receiving the model information of the at least one AI model corresponding to the DMRS pattern.

In some embodiments of the present disclosure, the information processing method performed by the UE may include: reporting first recommended information; where the first recommended information indicates the DMRS pattern used by the UE, or the first recommended information indicates the DMRS pattern used by the UE and indicates an AI model required by the UE; where the first recommended information is used for the base station to determine the model information.

One scenario in which the UE reports the first recommended information is that no matter whether there is an AI model corresponding to the DMRS pattern in the UE, the UE reports the first recommended information.

Another scenario in which the UE reports the first recommended information is that in response to determining that there is no AI model corresponding to the DMRS pattern in the UE, the UE reports the first recommended information.

Here, if the UE sends to the base station the first recommended information indicating the DMRS pattern used by the UE, the base station may determine the at least one AI model corresponding to the DMRS pattern based on the DMRS pattern. And then the base station may send to the UE model information including the at least one AI model corresponding to the DMRS pattern.

Here, if the UE sends to the base station the first recommended information indicating the AI model required by the UE, the base station may send to the UE model information including the AI model required by the UE. Here, the AI model required by the UE is determined by the UE based on the DMRS pattern.

In this way, in embodiments of the present disclosure, if there is no AI model required by the UE (i.e., the AI model corresponding to the DMRS pattern that needs to be used) in the UE, the UE may report the first recommended information to the base station to make the UE to obtain the AI model that the UE needs to use.

In another example, no matter whether there is an AI model corresponding to the DMRS pattern in the UE, the UE reports the first recommended information to obtain the AI model corresponding to the DMRS pattern that the UE needs to use.

Here, only when it is determined that there is no AI model corresponding to the DMRS pattern to be used by the UE, the UE obtains the AI model corresponding to the DMRS pattern to be used by the UE sent by the base station and the like. As the model information of the AI model is only received when there is no AI model to be used by the UE in the UE, signaling overhead can be further saved.

In the step S71, one AI model or a plurality of AI models corresponding to each DMRS pattern may be determined according to the protocol agreement. The protocol agreement may be set in a wireless communication protocol or may be agreed on between the UE and the base station.

The UE may determine, by the protocol agreement, at least one AI model corresponding to the DMRS pattern from the network deployment information stored in the UE.

In this way, in the embodiments of the present disclosure, the UE may determine the AI model corresponding to the DMRS pattern by the protocol agreement so that the UE may obtain the AI model that the UE needs to use. Moreover, in the embodiments of the present disclosure, the AI model corresponding to the DMRS pattern may be determined from the network deployment information in the UE, without needing to receive model information including the AI model from the network device such as a base station, and also saving signaling overhead.

Determining whether to use the AI model corresponding to the DMRS pattern for channel estimation in the step S31 includes one of the following: in response to that there is the AI model corresponding to the DMRS pattern in the UE, determining to use the AI model corresponding to the DMRS pattern for channel estimation; and in response to that there is no AI model corresponding to the DMRS pattern in the UE, determining not to use the AI model corresponding to the DMRS pattern for channel estimation.

In some embodiments of the present disclosure, the information processing method performed by the UE may include: in response to that there is the AI model corresponding to the DMRS pattern in the UE, determining to use the AI model corresponding to the DMRS pattern for channel estimation.

In an example, in response to the UE determining that the number of the AI model corresponding to the DMRS pattern is one, it is determined that the AI model corresponding to the DMRS pattern is used for channel estimation.

In an example, in response to the UE determining that the number of the AI models corresponding to the DMRS pattern is a plurality, based on the AI model indication information, one AI model is determined from the plurality of AI models for channel estimation.

In some embodiments of the present disclosure, the information processing method performed by the UE may include: in response to there being no AI model corresponding to the DMRS pattern in the UE, determining not to use the AI model corresponding to the DMRS pattern for channel estimation.

Determining not to use the AI model corresponding to the DMRS pattern for channel estimation may be: not using the AI model corresponding to the DMRS pattern for channel estimation, but using an AI model other than the AI model corresponding to the DMRS pattern for channel estimation; or, not using any AI model for channel estimation.

In this way, in embodiments of the present disclosure, in response to that there is the AI model corresponding to the DMRS pattern in the UE, channel estimation can be performed based on the AI model corresponding to the DMRS pattern, and in response to that there is no AI model corresponding to the DMRS pattern in the UE, channel estimation can be performed without using the AI model corresponding to the DMRS pattern. In this way, the UE may accurately determine whether to enable the AI model for channel estimation, and/or, which AI model is required for channel estimation.

In some embodiments of the present disclosure, the information processing method performed by the UE may include: sending the first recommended information; where the first recommended information indicates the DMRS pattern used by the UE, or where the first recommended information indicates the DMRS pattern used by the UE and indicates the AI model required by the UE; in response to receiving the model information of the at least one AI model corresponding to the DMRS pattern returned based on the first recommended information, determining to use the AI model corresponding to the DMRS pattern for channel estimation; or in response to not receiving the model information including the at least one AI model corresponding to the DMRS pattern, determining not to use the AI model corresponding to the DMRS pattern for channel estimation.

In this way, in embodiments of the present disclosure, the UE may proactively obtain the AI model required by the UE for channel estimation when there is no AI model for channel estimation in the UE, thereby adapting to more scenarios in which AI models are utilized for channel estimation.

It is to be noted that a person skilled in the art may understand that the methods provided by the embodiments of the present disclosure may be performed alone or in conjunction with some of the methods in the embodiments of the present disclosure or some of the methods in the related art.

The following information processing method, which is performed by a base station, is similar to the description of the information processing method performed by the UE described herein. And, for technical details not disclosed in the embodiment of the information processing method performed by the base station, please refer to the description of the example of the information processing method performed by the UE, and the technical details will not be described and illustrated in detail herein.

As shown in FIG. 8, an embodiment of the present disclosure provides an information processing method, performed by the base station and including step S81.

Step S81: configuration information for indicating the number of AI models corresponding to the DMRS pattern is sent, where the number of the AI models corresponding to the DMRS pattern is for instructing the UE to determine the AI model to perform channel estimation according to the number of AI models corresponding to the DMRS pattern.

The step S81 may be: sending to the UE the configuration information for indicating the number of AI models corresponding to the DMRS pattern.

In an embodiment, the number of the AI models corresponding to the DMRS pattern in the configuration information being for instructing the UE to determine the AI model to perform channel estimation according to the number of AI models corresponding to the DMRS pattern includes one of the following: i) in response to the number of the AI model corresponding to the DMRS pattern is one, the configuration information being for instructing the UE to use the AI model corresponding to the DMRS pattern to perform channel estimation; ii) in response to the number of the AI models corresponding to the DMRS pattern is a plurality, the configuration information being for instructing the UE to determine, based on AI model indication information, one AI model from the plurality of AI models corresponding to the DMRS pattern to perform channel estimation; iii) in response to the number of the AI models corresponding to the DMRS pattern is a plurality, the configuration information being for instructing the UE to determine any one of the plurality of AI models to perform channel estimation; or iv) in response to the number of the AI models corresponding to the DMRS pattern is a plurality, the configuration information being for instructing the UE to select one AI model matching one of moving speed of the UE, channel quality, computational capability of the UE, and storage capability of the UE from the plurality of AI models.

In an embodiment, the configuration information is for instructing the UE whether to use the AI model corresponding to the DMRS pattern for channel estimation.

In another embodiment, the configuration information, may further include: the DMRS pattern; where the DMRS pattern is for instructing the UE to determine whether to use the AI model corresponding to the DMRS pattern for channel estimation.

In some embodiments of the present disclosure, the information processing method performed by the base station may include: sending the configuration information that indicates the DMRS pattern before sending the configuration information for indicating the number of the AI models corresponding to the DMRS; where the DMRS pattern is for the UE to determine whether to use the AI model corresponding to the DMRS pattern for channel estimation.

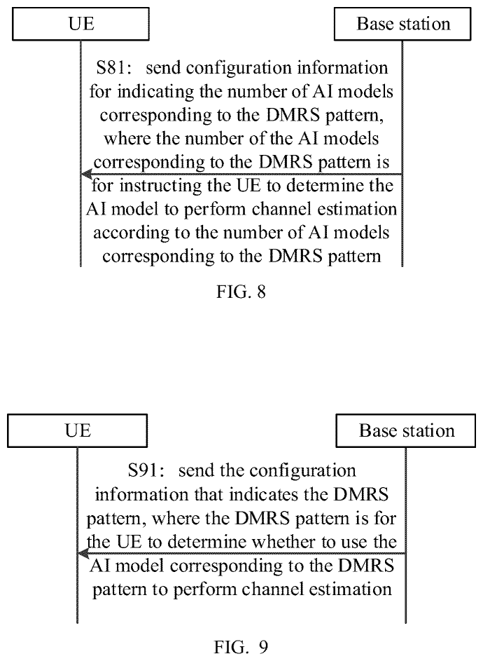

As shown in FIG. 9, an embodiment of the present disclosure provides an information processing method, performed by the base station and including step S91.

Step S91: the configuration information that indicates the DMRS pattern is sent, where the DMRS pattern is for the UE to determine whether to use the AI model corresponding to the DMRS pattern for channel estimation.

In some embodiments of the present disclosure, the configuration information in this step S91 may be the configuration information in the embodiments described herein.

The configuration information may include: the AI indication information for indicating whether to enable the AI model for channel estimation; where in response to the AI indication information indicating to enable the AI model for channel estimation, the AI indication information is for the UE to use the AI model corresponding to the DMRS pattern for channel estimation.

The configuration information may include: the AI model indication information for instructing the UE to select the AI model for channel estimation from the AI models corresponding to the DMRS pattern.

The step S91 may be: sending to the UE the configuration information that indicates the DMRS pattern.

In some embodiments of the present disclosure, the information processing method performed by the base station may include: sending the model deployment information of the UE; where the model deployment information includes: at least one correspondence between DMRS pattern and AI model; the correspondence includes: a correspondence between one DMRS pattern and one AI model, and/or a correspondence between one DMRS pattern and a plurality of AI models.

The base station may deploy one or more DMRS patterns and the AI models corresponding to the DMRS patterns for the UE in advance. In an example, the base station may determine the number of the DMRS patterns used by the UE based on at least one of mobility information, channel quality information, computational capability information, or storage capability information of the UE.

For example, there are 10 available DMRS patterns in a network system, 3 DMRS patterns of which are commonly used by UEs. For a UE with a relatively high moving speed, a relatively poor channel environment, a relatively strong computational capability, and/or a relatively large storage capability, all or most of the 10 DMRS patterns may be deployed for the UE. For a UE with a relatively low moving speed, a relatively good channel environment, a relatively weak computational capability, and/or a relatively small storage capability, all or part of the 3 common-used DMRS patterns or a small part of such 10 DMRS patterns may be deployed for the UE.

In the above example, if the DMRS pattern corresponds to a plurality of AI models, for a UE with a relatively high moving speed, a relatively poor channel environment, a relatively strong computational capability, and/or a relatively large storage capability, all or most of the plurality of AI models may be deployed; and for a UE with a relatively low moving speed, a relatively good channel environment, a relatively weak computational capability, and/or a relatively small storage capability, one or a small part of the plurality of AI models may be deployed.

In this way, it is possible to adapt to changes in the DMRS pattern, to obtain in a timely manner the number of the DMRS patterns and/or AI model data, etc. that are suitable to match the current mobility, channel environment, computational capability and/or storage capability of the UE.

The base station may also deploy the DMRS pattern and the AI model corresponding to the DMRS pattern for the UE based on needs of the UE. In an example, the base station may send to the UE the model information of the AI model corresponding to the DMRS pattern based on the first recommended information carrying the indicated DMRS pattern and reported by the UE.

In this way, in embodiments of the present disclosure, it is possible to select a suitable AI model for deployment for the UE, thereby saving communication overhead, storage and computation overhead, etc., required for model deployment for the UE.

In some embodiments of the present disclosure, the information processing method performed by the base station may include: storing model deployment information of each UE. In this way, it may be convenient for the base station to determine whether the AI model corresponding to the DMRS pattern is stored in the UE.

In some embodiments of the present disclosure, the information processing method performed by the base station may include: in response to determining that there is no AI model corresponding to the DMRS pattern in the UE, sending the model information of the at least one AI model corresponding to the DMRS pattern.

In an example, the base station may determine, based on the stored model deployment information of the UE, whether there is the AI model corresponding to the DMRS pattern in the UE. In response to determining that there is no AI model corresponding to the DMRS pattern in the UE, the base station sends the model information of the at least one AI model corresponding to the DMRS pattern.

In some embodiments of the present disclosure, the information processing method performed by the base station may include: receiving the second recommended information; and determining the configuration information based on the DMRS pattern recommended for use by the UE and indicated by the second recommended information.

The base station receives the second recommended information sent by the UE, and may determine whether the UE enables the AI model for channel estimation based on the DMRS pattern recommended for use by the UE and indicated by the second recommended information, and/or, determine the DMRS pattern used by the UE. The base station may send to the UE the configuration information indicating the DMRS pattern and/or including the AI model indication information.

If the base station determines that the DMRS pattern used by the UE corresponds to a plurality of AI models, the base station may further send to the UE configuration information including the AI model indication information.

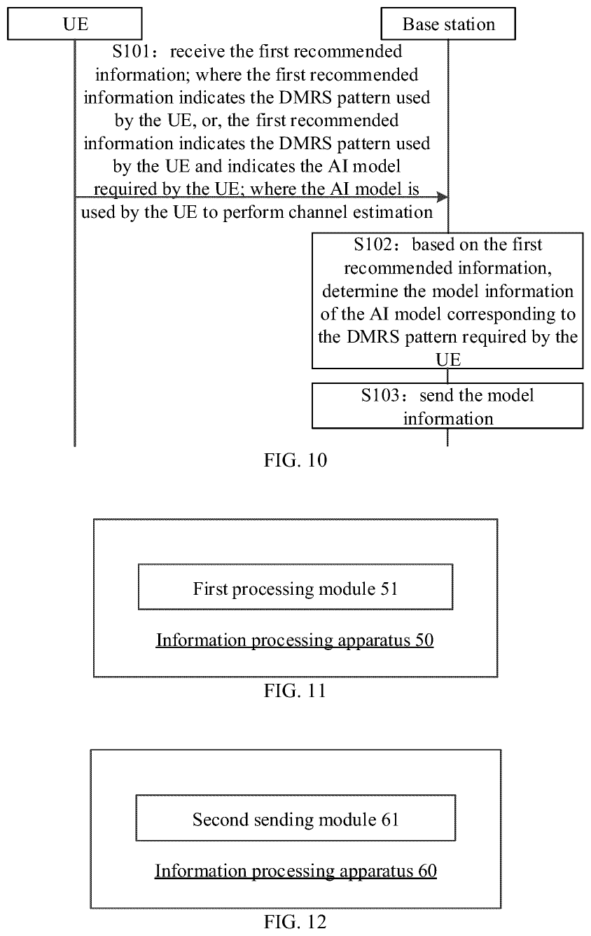

As shown in FIG. 10, an embodiment of the present disclosure provides an information processing method, performed by the base station and including steps S101-S103.

Step S101: the first recommended information is received; where the first recommended information indicates the DMRS pattern used by the UE, or, the first recommended information indicates the DMRS pattern used by the UE and indicates the AI model required by the UE; where the AI model is used by the UE to perform channel estimation.

Step S102: based on the first recommended information, the model information of the AI model corresponding to the DMRS pattern required by the UE is determined.

Step S103: the model information is sent.

Here, the base station determining the model information of the AI model required by the UE may be: determining the model information of one AI model corresponding to the DMRS pattern, or, determining the model information of a plurality of AI models corresponding to the DMRS pattern.

The included embodiments can be specifically referred to the embodiments of the UE, the details of which will not be repeated here.

It is to be noted that a person skilled in the art may understand that the methods provided by the embodiments of the present disclosure may be performed alone or in conjunction with some of the methods in the embodiments of the present disclosure or some of the methods in the related art.

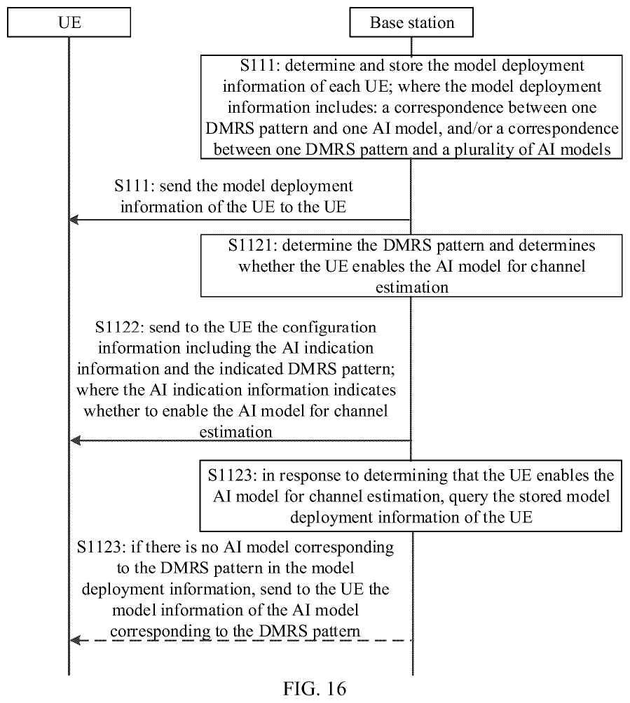

To further explain any embodiment of the present disclosure, a specific embodiment is provided below. The steps shown in FIGS. 16-21 are for illustrative purposes only and do not limit the specific execution sequence of the steps, and some of them can be parallel in function, omitted, and reversed, and so on.

As shown in FIG. 16, the embodiment of the present disclosure provides an information processing method that may include the following steps.

Step S111: the base station determines and stores the model deployment information of each UE; where the model deployment information includes: a correspondence between one DMRS pattern and one AI model, and/or a correspondence between one DMRS pattern and a plurality of AI models; and the base station sends the model deployment information of the UE to the UE.

In a case I where one DMRS pattern corresponds to one AI model, there are several methods of configuring AI channel estimation parameters as follows.

Method A1: a method of configuring AI channel estimation parameters based on the base station.

Step S1121: the base station determines the DMRS pattern and determines whether the UE enables the AI model for channel estimation.

Step S1122: the base station sends to the UE the configuration information including the AI indication information and the indicated DMRS pattern; where the AI indication information indicates whether to enable the AI model for channel estimation.

Step S1123: the base station, in response to determining that the UE enables the AI model for channel estimation, queries the stored model deployment information of the UE; if there is no AI model corresponding to the DMRS pattern in the model deployment information, the base station sends to the UE the model information of the AI model corresponding to the DMRS pattern.

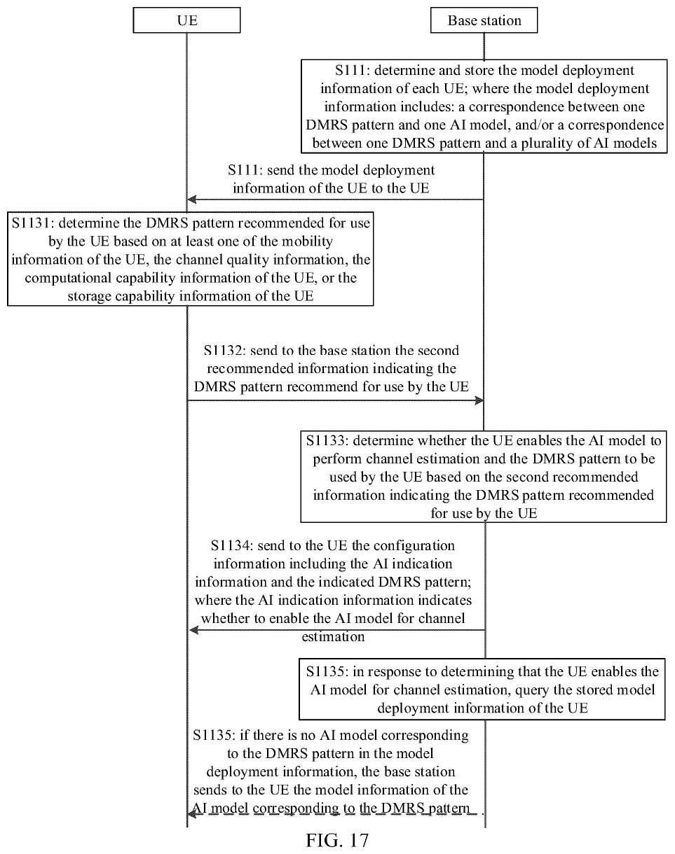

Method B1: a method of configuring AI channel estimation parameters based on the recommended information reported by the UE, which is shown in FIG. 17.

Step S1131: the UE determines the DMRS pattern recommended for use by the UE based on at least one of the mobility information of the UE, the channel quality information, the computational capability information of the UE, or the storage capability information of the UE.

Step S1132: the UE sends to the base station the second recommended information indicating the DMRS pattern recommend for use by the UE.

Step S1133: the base station determines whether the UE enables the AI model to perform channel estimation and the DMRS pattern to be used by the UE based on the second recommended information indicating the DMRS pattern recommended for use by the UE.

Step S1134: the base station sends to the UE the configuration information including the AI indication information and the indicated DMRS pattern; where the AI indication information indicates whether to enable the AI model for channel estimation.

Step S1135: the base station, in response to determining that the UE enables the AI model for channel estimation, queries the stored model deployment information of the UE; if there is no AI model corresponding to the DMRS pattern in the model deployment information, the base station sends to the UE the model information of the AI model corresponding to the DMRS pattern.

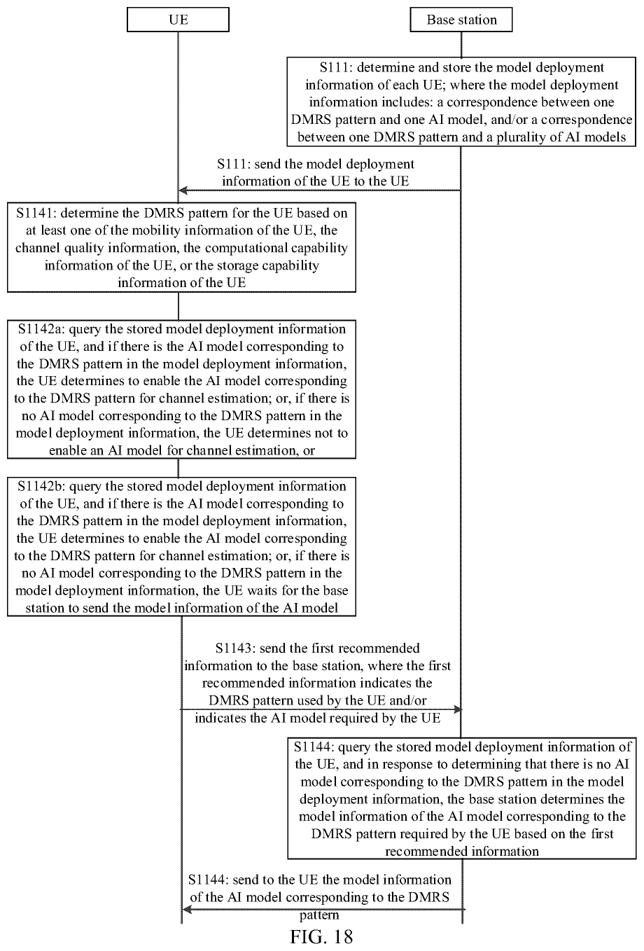

Method C1: a method of configuring AI channel estimation parameters based on the UE, which is shown in FIG. 18.

Step S1141: the UE determines the DMRS pattern for the UE based on at least one of the mobility information of the UE, the channel quality information, the computational capability information of the UE, or the storage capability information of the UE.

Step S1142a: the UE queries the stored model deployment information of the UE, and if there is the AI model corresponding to the DMRS pattern in the model deployment information, the UE determines to enable the AI model corresponding to the DMRS pattern for channel estimation; or, if there is no AI model corresponding to the DMRS pattern in the model deployment information, the UE determines not to enable an AI model for channel estimation.

In another example, step S1142b: the UE queries the stored model deployment information of the UE, and if there is the AI model corresponding to the DMRS pattern in the model deployment information, the UE determines to enable the AI model corresponding to the DMRS pattern for channel estimation; or, if there is no AI model corresponding to the DMRS pattern in the model deployment information, the UE waits for the base station to send the model information of the AI model.

Step S1143: the UE sends the first recommended information to the base station, where the first recommended information indicates the DMRS pattern used by the UE and/or indicates the AI model required by the UE.

Step S1144: the base station queries the stored model deployment information of the UE, and in response to determining that there is no AI model corresponding to the DMRS pattern in the model deployment information, the base station determines the model information of the AI model corresponding to the DMRS pattern required by the UE based on the first recommended information; and the base station sends to the UE the model information of the AI model corresponding to the DMRS pattern.

In a case II where one DMRS pattern corresponding to a plurality of AI models, there are several methods of configuring AI channel estimation parameters as follows.

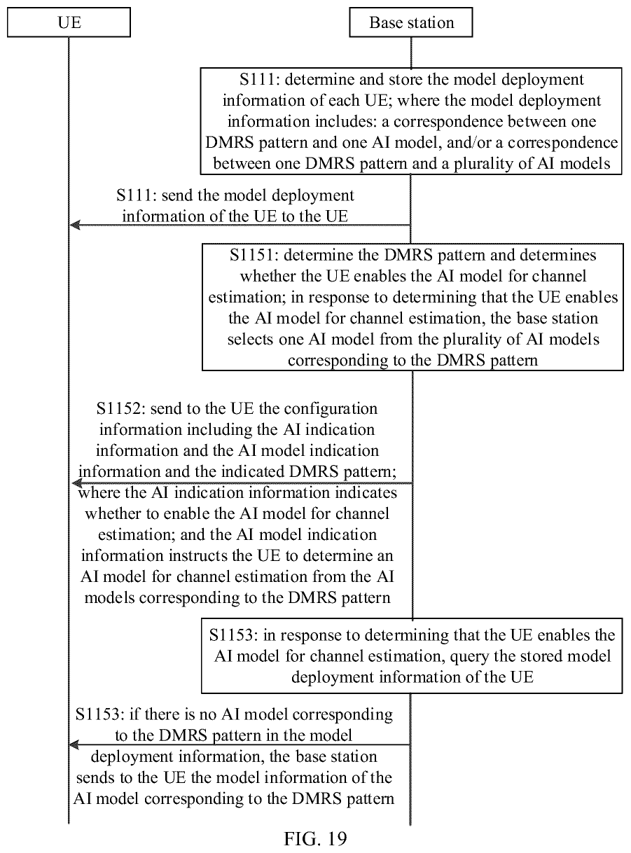

Method A2: a method of configuring AI channel estimation parameters based on the base station, which is shown in FIG. 19.

Step S1151: the base station determines the DMRS pattern and determines whether the UE enables the AI model for channel estimation; in response to determining that the UE enables the AI model for channel estimation, the base station selects one AI model from the plurality of AI models corresponding to the DMRS pattern.

Step S1152: the base station sends to the UE the configuration information including the AI indication information and the AI model indication information and the indicated DMRS pattern; where the AI indication information indicates whether to enable the AI model for channel estimation; and the AI model indication information instructs the UE to determine an AI model for channel estimation from the AI models corresponding to the DMRS pattern.

Step S1153: the base station, in response to determining that the UE enables the AI model for channel estimation, queries the stored model deployment information of the UE; if there is no AI model corresponding to the DMRS pattern in the model deployment information, the base station sends to the UE the model information of the AI model corresponding to the DMRS pattern.

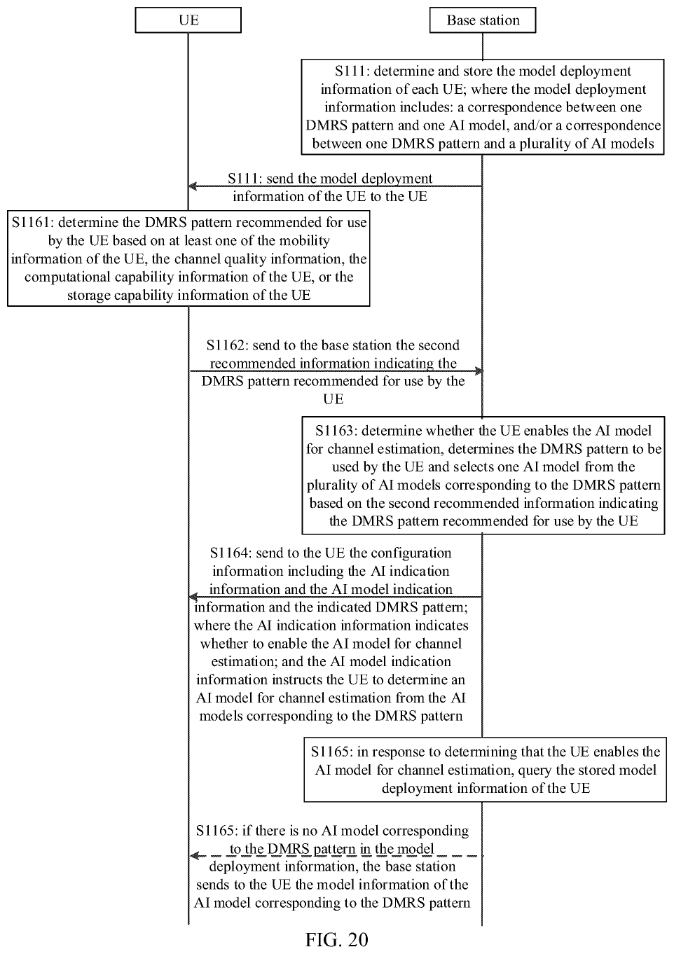

Method B2: a method of configuring AI channel estimation parameters based on the recommended information reported by the UE, which is shown in FIG. 20.

Step S1161: the UE determines the DMRS pattern recommended for use by the UE based on at least one of the mobility information of the UE, the channel quality information, the computational capability information of the UE, or the storage capability information of the UE.

Step S1162: the UE sends to the base station the second recommended information indicating the DMRS pattern recommended for use by the UE.

Step S1163: the base station determines whether the UE enables the AI model for channel estimation, determines the DMRS pattern to be used by the UE and selects one AI model from the plurality of AI models corresponding to the DMRS pattern based on the second recommended information indicating the DMRS pattern recommended for use by the UE.

Step S1164: the base station sends to the UE the configuration information including the AI indication information and the AI model indication information and the indicated DMRS pattern; where the AI indication information indicates whether to enable the AI model for channel estimation; and the AI model indication information instructs the UE to determine an AI model for channel estimation from the AI models corresponding to the DMRS pattern.

Step S1165: the base station, in response to determining that the UE enables the AI model for channel estimation, queries the stored model deployment information of the UE; if there is no AI model corresponding to the DMRS pattern in the model deployment information, the base station sends to the UE the model information of the AI model corresponding to the DMRS pattern.

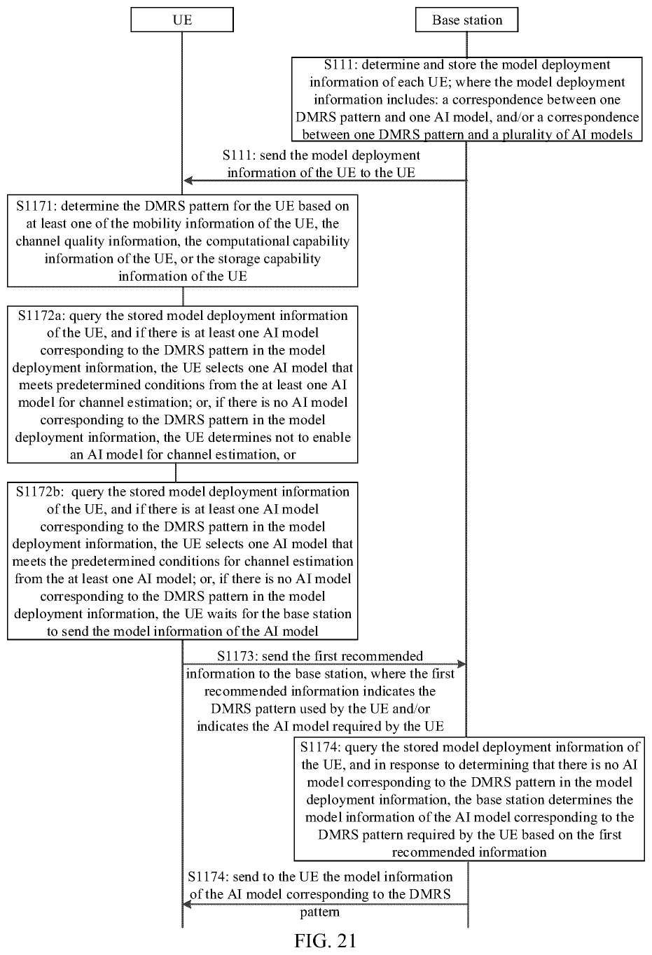

Method C2: a method of determining AI channel estimation parameters based on the UE, which is shown in FIG. 21.

Step S1171: the UE determines the DMRS pattern for the UE based on at least one of the mobility information of the UE, the channel quality information, the computational capability information of the UE, or the storage capability information of the UE.

Step S1172a: the UE queries the stored model deployment information of the UE, and if there is at least one AI model corresponding to the DMRS pattern in the model deployment information, the UE selects one AI model that meets predetermined conditions from the at least one AI model for channel estimation; or, if there is no AI model corresponding to the DMRS pattern in the model deployment information, the UE determines not to enable an AI model for channel estimation.

Here, selecting one AI model that meets the predetermined conditions from the at least one AI model may be, but is not limited to, one of the following: selecting any one AI model from the at least one AI model; or selecting one AI model that matches one of the moving speed of the UE, channel quality, computational capability of the UE, or storage capability of the UE from the at least one AI model.

In another example, step S1172b: the UE queries the stored model deployment information of the UE, and if there is at least one AI model corresponding to the DMRS pattern in the model deployment information, the UE selects one AI model that meets the predetermined conditions for channel estimation from the at least one AI model; or, if there is no AI model corresponding to the DMRS pattern in the model deployment information, the UE waits for the base station to send the model information of the AI model.

Step S1173: the UE sends the first recommended information to the base station, where the first recommended information indicates the DMRS pattern used by the UE and/or indicates the AI model required by the UE.

Step S1174: the base station queries the stored model deployment information of the UE, and in response to determining that there is no AI model corresponding to the DMRS pattern in the model deployment information, the base station determines the model information of the AI model corresponding to the DMRS pattern required by the UE based on the first recommended information; and the base station sends to the UE the model information of the AI model corresponding to the DMRS pattern.

It is to be noted that a person skilled in the art may understand that the methods provided by the embodiments of the present disclosure may be performed alone or in conjunction with some of the methods in the embodiments of the present disclosure or some of the methods in the related art.

As shown in FIG. 11, an embodiment of the present disclosure provides an information processing apparatus 50, applied to a UE, including a first processing module 51.

The first processing module 51 is configured for according to a number of AI models corresponding to a DMRS pattern, using the AI model corresponding to the DMRS pattern to perform channel estimation.

In some embodiments of the present disclosure, the information processing apparatus 50 applied to the UE may include: the first processing module 51, configured for in response to the number of the AI model corresponding to the DMRS pattern is one, using the AI model corresponding to the DMRS pattern to perform channel estimation.

In some embodiments of the present disclosure, the information processing apparatus 50 applied to the UE may include: the first processing module 51, configured for in response to the number of the AI models corresponding to the DMRS pattern is a plurality, based on AI model indication information, determining one AI model from the plurality of AI models corresponding to the DMRS pattern to perform channel estimation.

In some embodiments of the present disclosure, the information processing apparatus 50 applied to the UE may include: the first processing module 51, configured for in response to the number of the AI models corresponding to the DMRS pattern is a plurality, determining any one of the plurality of AI models to perform channel estimation.

In some embodiments of the present disclosure, the information processing apparatus 50 applied to the UE may include: the first processing module 51, configured for in response to the number of the AI models corresponding to the DMRS pattern is a plurality, selecting one AI model matching one of a moving speed of the UE, channel quality, computational capability of the UE, and storage capability of the UE from the plurality of AI models.

In some embodiments of the present disclosure, the information processing apparatus 50 applied to the UE may include: a determining module configured for determining the DMRS pattern.

In some embodiments of the present disclosure, the information processing apparatus 50 applied to the UE may include: the first processing module 51 configured for determining whether to use the AI model to perform channel estimation.

In some embodiments of the present disclosure, the information processing apparatus 50 applied to the UE may include: the first processing module 51 configured for determining whether to use the AI model to perform channel estimation.

In some embodiments of the present disclosure, the information processing apparatus 50 applied to the UE may include: the determining module, configured for receiving configuration information that indicates the DMRS pattern.

In some embodiments of the present disclosure, the information processing apparatus 50 applied to the UE may include: the determining module, configured for determining the DMRS pattern based on at least one of mobility information, channel quality information, computational capability information, or storage capability information of the UE.

In some embodiments of the present disclosure, the information processing apparatus 50 applied to the UE may include: the determining module, configured for receiving the configuration information that indicates the DMRS pattern; the configuration information further includes: AI indication information, for indicating whether to enable the AI model to perform channel estimation.

In some embodiments of the present disclosure, the information processing apparatus 50 applied to the UE may include: the determining module, configured for receiving configuration information that indicates the DMRS pattern; where the configuration information further includes: AI model indication information, for instructing the UE to determine the AI model for channel estimation from the AI models corresponding to the DMRS pattern.

In some embodiments of the present disclosure, the information processing apparatus 50 applied to the UE may include: a first receiving module, configured for receiving model information of at least one AI model corresponding to the DMRS pattern.

In some embodiments of the present disclosure, the information processing apparatus 50 applied to the UE may include: the determining module, configured for determining model information of at least one AI model corresponding to the DMRS pattern according to a protocol agreement.

In some embodiments of the present disclosure, the information processing apparatus 50 applied to the UE may include: the first receiving module, configured for in response to that there is no AI model corresponding to the DMRS pattern in the UE, receiving the model information of the at least one AI model corresponding to the DMRS pattern.

In some embodiments of the present disclosure, the information processing apparatus 50 applied to the UE may include: a first sending module, configured for reporting first recommended information; where the first recommended information indicates the DMRS pattern used by the UE and/or the AI model required by the UE; where the first recommended information is for the base station to determine the model information.

In some embodiments of the present disclosure, the information processing apparatus 50 applied to the UE may include: the first processing module 51, configured for in response to the number of the AI model corresponding to the DMRS pattern is one, using the AI model corresponding to the DMRS pattern to perform the channel estimation.

In some embodiments of the present disclosure, the information processing apparatus 50 applied to the UE may include: the first processing module 51, configured for in response to the number of the AI models corresponding to the DMRS pattern is a plurality, based on AI model indication information, determining one AI model from the plurality of AI models corresponding to the DMRS pattern to perform channel estimation.

In some embodiments of the present disclosure, the information processing apparatus 50 applied to the UE may include: the first processing module 51, configured for in response to that there is the AI model corresponding to the DMRS pattern in the UE, determining to use the AI model corresponding to the DMRS pattern to perform channel estimation.

In some embodiments of the present disclosure, the information processing apparatus 50 applied to the UE may include: the first processing module 51, configured for in response to that there is no AI model corresponding to the DMRS pattern in the UE, determining not to use the AI model corresponding to the DMRS pattern to perform channel estimation.

In some embodiments of the present disclosure, the information processing apparatus 50 applied to the UE may include: a first sending module, configured for reporting second recommended information, where the second recommended information indicates a DMRS pattern recommended for use by the UE and is for the base station to determine the configuration information.

In some embodiments of the present disclosure, the information processing apparatus 50 applied to the UE may include: the determining module, configured for determining the DMRS pattern recommended for use by the UE based on at least one of the mobility information, the channel quality information, the computational capability information, or the storage capability information of the UE.

As shown in FIG. 12, an embodiment of the present disclosure provides an information processing apparatus 60, applied to a base station, including a second sending module 61.

The second sending module 61 is configured for sending configuration information for indicating a number of AI models corresponding to a DMRS pattern, where the number of the AI models corresponding to the DMRS pattern is for instructing a UE to determine an AI model to perform channel estimation according to the number of AI models corresponding to the DMRS pattern.

In some embodiments, the number of the AI models corresponding to the DMRS pattern in the configuration information being for instructing the UE to determine the AI model to perform channel estimation according to the number of AI models corresponding to the DMRS pattern includes one of the following: i) in response to the number of the AI model corresponding to the DMRS pattern is one, the configuration information being for instructing the UE to use the AI model corresponding to the DMRS pattern to perform the channel estimation; ii) in response to the number of the AI models corresponding to the DMRS pattern is a plurality, the configuration information being for instructing the UE to determine, based on AI model indication information, one AI model from the plurality of AI models to perform channel estimation; iii) in response to the number of the AI models corresponding to the DMRS pattern is a plurality, the configuration information being for instructing the UE to determine any one of the plurality of AI models to perform channel estimation; or iv) in response to the number of the AI models corresponding to the DMRS pattern is a plurality, the configuration information being for instructing the UE to select one AI model matching one of a moving speed of the UE, channel quality, computational capability of the UE, and storage capability of the UE from the plurality of AI models.

In some embodiments, the configuration information includes: the DMRS pattern; and the configuration information being for instructing the UE whether to use the AI model corresponding to the DMRS pattern to perform channel estimation.

In other embodiments, the configuration information includes: the DMRS pattern; and where the DMRS pattern is for the UE to determine whether to use the AI model corresponding to the DMRS pattern for channel estimation before determining to use the AI model corresponding to the DMRS pattern for channel estimation.

In some embodiments of the present disclosure, the information processing apparatus 60 applied to the base station may include: the second sending module 61, configured for sending the configuration information that indicates the number of AI models corresponding to the DMRS pattern before sending the configuration information that indicates the DMRS pattern.

In some embodiments of the present disclosure, the information processing apparatus 60 applied to the base station may include: the second sending module 61, configured for sending the configuration information that indicates the DMRS pattern, where the DMRS pattern is for the UE to determine whether to use the AI model corresponding to the DMRS pattern for channel estimation.

In some embodiments, the configuration information, further includes: AI indication information, for indicating whether to enable the AI model to perform channel estimation; where, in response to the AI indication information indicating to enable the AI model to perform channel estimation, the AI indication information is for instructing the UE to use the AI model corresponding to the DMRS pattern to perform channel estimation.

In some embodiments, the configuration information further includes: AI model indication information, for instructing the UE to select the AI model to perform channel estimation from the AI models corresponding to the DMRS pattern.

The information processing apparatus 60 provided by embodiments of the present disclosure, applied to the base station, may include: the second sending module, configured for in response to determining that there is no AI model corresponding to the DMRS pattern in the UE, sending model information of at least one of the AI models corresponding to the DMRS pattern.

The information processing apparatus 60 provided by embodiments of the present disclosure, applied to the base station, may include: a second receiving module, configured for receiving second recommended information; and a second processing module, configured for determining the configuration information based on the DMRS pattern recommended for use by the UE and indicated by the second recommended information.

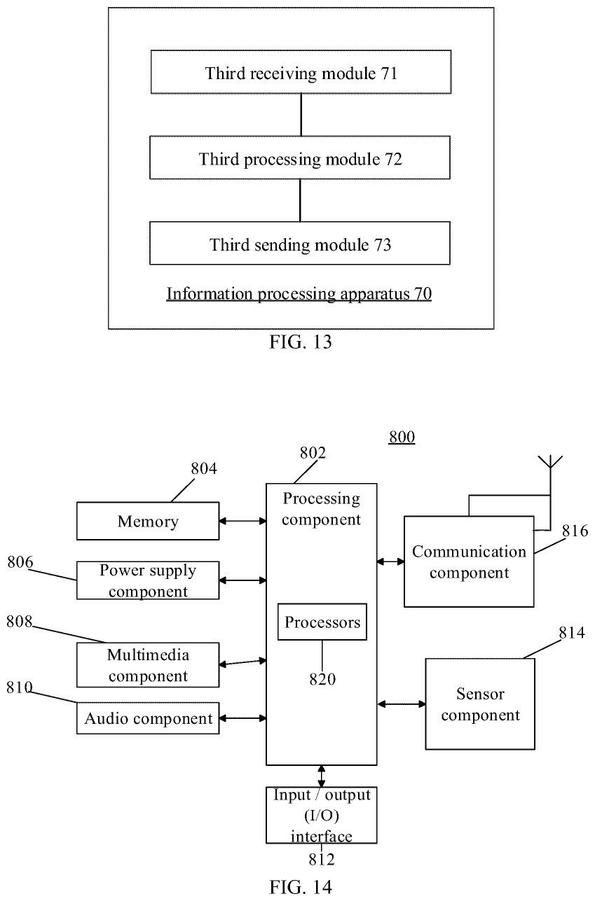

As shown in FIG. 13, an embodiment of the present disclosure provides an information processing apparatus 70, applied to the base station, including a third receiving module 71, a third processing module 72, and a third sending module 73.

The third receiving module 71 is configured for receiving first recommended information; where the first recommended information indicates a DMRS pattern used by a UE, or the first recommended information indicates the DMRS pattern used by the UE and an AI model required by the UE; where the AI model is for the UE to perform channel estimation.

The third processing module 72 is configured for determining, based on the first recommended information, model information of the AI model corresponding to the DMRS pattern required by the UE.

The third sending module 73 is configured for sending the model information.

It is to be noted that a person skilled in the art may understand that the methods provided by the embodiments of the present disclosure may be performed alone or in conjunction with some of the methods in the embodiments of the present disclosure or some of the methods in the related art.

With respect to the apparatuses in the included embodiments, the specific methods in which each module performs an operation has been described in detail in the embodiments relating to the method, and will not be described in detail herein.

Embodiments of the present disclosure provide a communication device including: a processor; and a memory for storing executable instructions for the processor. Where the processor is configured for executing the executable instructions to implement the information processing method of any embodiment of the present disclosure.

In an embodiment, the communication device may be a base station or a UE.

The processor may include various types of storage media that are non-transitory computer storage media capable of continuing to memorize information stored thereon after the user equipment is powered down.

The processor may be connected to the memory via a bus, etc., for reading an executable program stored on the memory, e.g., at least one of the methods as shown in FIGS. 2 to 10.

Embodiments of the present disclosure also provide a computer storage medium, the computer storage medium storing a computer executable program, where the executable program is executed by a processor to implement the information processing method of any embodiment of the present disclosure, for example, at least one of the methods as shown in FIGS. 2 through 10.

With respect to the apparatuses in the included embodiments, the specific methods in which each module performs an operation has been described in detail in the embodiments relating to the method, and will not be described in detail herein.

FIG. 14 is a block diagram illustrating a user equipment 800 according to an example. For example, the user equipment 800 may be a mobile phone, a computer, a digital broadcast user equipment, a message transceiving device, a game console, a tablet device, a medical device, a fitness device and a personal digital assistant and so on.

Referring to FIG. 14, the user equipment 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operation of the user equipment 800, such as operations associated with displays, phone calls, data communications, camera operations, and recording operations. The processing component 802 may include one or more processors 820 to execute instructions to complete all or a part of the blocks of the included methods. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations at the user equipment 800. Examples of such data include instructions for any application program or method operable on the user equipment 800, contact data, telephone directory data, messages, pictures, videos, and the like. The memory 804 may be implemented by a any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or a CD.

The power supply component 806 provides power to various components of the user equipment 800. The power supply component 806 may include a power management system, one or more power supplies, and other components associated with generating, managing, and distributing power for the user equipment 800.

The multimedia component 808 may include a screen providing an output interface between the user equipment 800 and a user. In some embodiments, the screen may include a liquid crystal display (LCD) and a touch panel (TP). If the screen includes a touch panel, the screen may be implemented as a touch screen to receive input signals from a user. The touch panel may include one or more touch sensors to sense a touch, a slide and a gesture on the touch panel. The touch sensor may not only sense a boundary of a touching or sliding movement, but also detect duration and pressure related to the touching or sliding operation. In some embodiments, the multimedia component 808 may include a front camera and/or a rear camera. When the user equipment 800 is in an operating mode, such as a shooting mode or a video mode, the front camera and/or the rear camera may receive external multimedia data. Each of the front camera and the rear camera may be a fixed optical lens system or be of a focal length and a capability of an optical zoom.

The audio component 810 is configured to output and/or input audio signals. For example, the audio component 810 may include a microphone (MIC). When the user equipment 800 is in an operational mode, such as a call mode, a recording mode and a speech recognition mode, the microphone is configured to receive an external audio signal. The received audio signals may be further stored in the memory 804 or sent via the communication component 816. In some embodiments, the audio component 810 further includes a speaker for outputting an audio signal.

The I/O interface 812 may provide an interface between the processing component 802 and peripheral interface modules. The peripheral interface modules may include a keyboard, a click wheel, buttons and so on. These buttons may include but not limited to, a home button, a volume button, a start button and a lock button.

The sensor component 814 may include one or more sensors for providing state assessments in different aspects for the user equipment 800. For example, the sensor component 814 may detect the on/off state of the user equipment 800, relative locations of components, such as a display and a small keyboard of the user equipment 800. The sensor component 814 may also detect a position change of the user equipment 800 or of a component of the user equipment 800, the presence or absence of contact of a user with the user equipment 800, an orientation or acceleration/deceleration of the user equipment 800 and a temperature change of the user equipment 800. The sensor component 814 may include a proximity sensor for detecting the existence of a nearby object without any physical touch. The sensor component 814 may also include an optical sensor, such as a CMOS or CCD image sensor used in an imaging application. In some embodiments, the sensor component 814 may also include an acceleration sensor, a gyro sensor, a magnetic sensor, a pressure sensor, or a temperature sensor.

The communication component 816 is configured to facilitate wired or wireless communication between the user equipment 800 and other devices. The user equipment 800 may have access to a wireless network based on a communication standard, such as WiFi, 4G or 5G, or a combination thereof. In an example, the communication component 816 may receive a broadcast signal or broadcast-related information from an external broadcast management system via a broadcast channel. In an example, the communication component 816 further include a Near Field Communication (NFC) module to facilitate short-range communications. For example, the NFC module may be implemented based on radio frequency identity (RFID) technology, infrared data association (IrDA) technology, ultra-wideband (UWB) technology, bluetooth (BT) technology and other technologies.

In examples, the user equipment 800 may be implemented by one or more of an application-specific integrated circuit (ASIC), a digital signal processor (DSP), a digital signal processing device (DSPD), programmable logical device (PLD), field programmable gate array (FPGA), a controller, microcontroller, a microprocessor or other electronic components to execute the included methods.

In an example, a non-transitory machine readable storage medium storing machine executable instructions is provided, such as the memory 804 storing instructions. The instructions may cause the processor 820 in the user equipment 800 to perform the included methods. For example, the non-transitory computer readable storage medium may be a Read-Only Memory (ROM), a Random Access Memory (RAM), a CD-ROM, a magnetic tape, a floppy disk and an optical data storage device, etc.

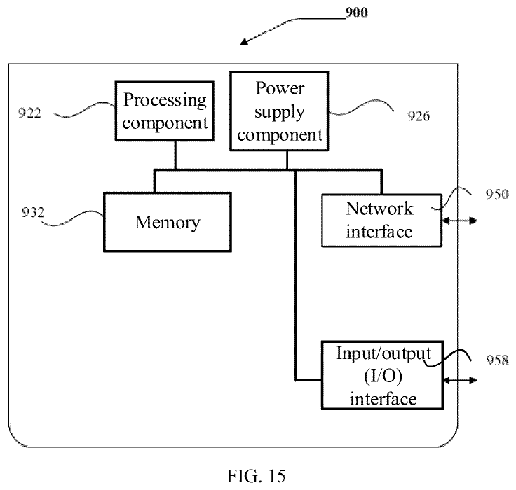

As shown in FIG. 15, an embodiment of the present disclosure illustrates an architecture of a base station. For example, the base station 900 may be provided as a network-side device. Referring to FIG. FIG. 15, the base station 900 includes a processing component 922, which further includes one or more processors (not shown), and a memory resource represented by a memory 932 for storing instructions, such as application programs, executed by the processing component 922. The application programs stored in the memory 932 may include one or more modules and each module corresponds to a set of instructions. In addition, the processing component 922 is configured to execute instructions to perform any of the methods applied to the base station described herein, e.g., as in the methods shown in FIGS. 4 to 10.

The base station 900 may also include a power supply component 926 configured to perform power management of the base station 900, a wired or wireless network interface 950 configured to connect the base station 900 to a network, and an input/output (I/O) interface 958. The base station 900 may operate based on an operating system, such as Windows Server™, Mac OS X™, Unix™, Linux™, FreeBSD™ or the like, stored in the memory 932.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the art that are not disclosed in the present disclosure. The specification and examples herein are intended to be illustrative only and the real scope and spirit of the present disclosure are indicated by the following claims of the present disclosure.

It is to be understood that the present disclosure is not limited to the precise structures described herein and shown in the accompanying drawings and may be modified or changed without departing from the scope of the present disclosure.

1. An information processing method, performed by a user equipment (UE), the information processing method comprising:
according to a quantity of one or more artificial intelligence (AI) models corresponding to a demodulation reference signal (DMRS) pattern, using an AI model of the one or more AI models corresponding to the DMRS pattern to perform channel estimation.

2. The information processing method according to claim 1, wherein according to the quantity of the one or more the AI models corresponding to the DMRS pattern, using the AI model corresponding to the DMRS pattern to perform the channel estimation comprises one of:
in response to the one or more AI models corresponding to the DMRS pattern being one AI model, using the one AI model to perform the channel estimation;
in response to the one or more AI models corresponding to the DMRS pattern being a plurality of AI models, based on AI model indication information, determining one AI model from the plurality of AI models to perform the channel estimation;
in response to the one or more AI models corresponding to the DMRS pattern being a plurality of AI models, determining any one of the plurality of AI models to perform the channel estimation; or
in response to the one or more AI models corresponding to the DMRS pattern being a plurality of AI models, selecting one AI model matching one of a moving speed of the UE, channel quality, computational capability of the UE, and storage capability of the UE from the plurality of AI models to perform the channel estimation.

3. The information processing method according to claim 1, further comprising:
determining whether to use the AI model to perform the channel estimation.

4. The information processing method according to claim 3, further comprising:
receiving configuration information that indicates the DMRS pattern; or
determining the DMRS pattern based on at least one of mobility information, channel quality information, computational capability information, or storage capability information of the UE.

5. The information processing method according to claim 4, wherein the configuration information further comprises: AI indication information for indicating whether to enable the AI model to perform the channel estimation.

6. The information processing method according to claim 4, wherein the configuration information further comprises: AI model indication information for instructing the UE to determine the AI model for the channel estimation from the one or more AI models corresponding to the DMRS pattern.

7. The information processing method according to claim 1, further comprising:
receiving model information of at least one of the one or more AI models corresponding to the DMRS pattern; or
determining model information of at least one of the one or more AI models corresponding to the DMRS pattern according to a protocol agreement.

8. The information processing method according to claim 7, wherein receiving the model information of the at least one of the one or more AI models corresponding to the DMRS pattern comprises:
in response to determining that there is no AI model corresponding to the DMRS pattern in the UE, receiving the model information of the at least one of the one or more AI models corresponding to the DMRS pattern.

9. The information processing method according to claim 7, further comprising:
reporting first recommended information, wherein the first recommended information indicates the DMRS pattern used by the UE, or the first recommended information indicates the DMRS pattern used by the UE and the AI model required by the UE; wherein the first recommended information is for the base station to determine the model information.

10. The information processing method according to claim 3, wherein determining whether to use the AI model to perform the channel estimation comprises one of:
in response to determining that there is the AI model corresponding to the DMRS pattern in the UE, determining to use the AI model corresponding to the DMRS pattern to perform the channel estimation; or
in response to determining that there is no AI model corresponding to the DMRS pattern in the UE, determining not to use the AI model corresponding to the DMRS pattern to perform the channel estimation.

11. The information processing method according to claim 4, further comprising:
reporting second recommended information, wherein the second recommended information indicates a DMRS pattern recommended for use by the UE and is for the base station to determine the configuration information.

12. The information processing method according to claim 11, comprising:
determining the DMRS pattern recommended for use by the UE based on at least one of the mobility information, the channel quality information, the computational capability information, or the storage capability information of the UE.

13. An information processing method, performed by a base station, the information processing method comprising:
sending configuration information for indicating a quantity of one or more artificial intelligence (AI) models corresponding to a demodulation reference signal (DMRS) pattern, wherein the quantity of the one or more AI models corresponding to the DMRS pattern is for instructing a user equipment (UE) to determine an AI model of the one or more AI models to perform channel estimation according to the quantity of the one or more AI models corresponding to the DMRS pattern.

14. The information processing method according to claim 13, wherein the quantity of the one or more AI models corresponding to the DMRS pattern in the configuration information being for instructing the UE to determine the AI model to perform the channel estimation according to the quantity of one or more AI models corresponding to the DMRS pattern, comprises one of:
in response to the one or more AI models corresponding to the DMRS pattern being one AI model, the configuration information being for instructing the UE to use the one AI model to perform the channel estimation;
in response to the one or more AI models corresponding to the DMRS pattern being a plurality of AI models, the configuration information being for instructing the UE to determine, based on AI model indication information, one AI model from the plurality of AI models to perform the channel estimation;
in response to the one or more AI models corresponding to the DMRS pattern being a plurality of AI models, the configuration information being for instructing the UE to determine any one of the plurality of AI models to perform the channel estimation; or
in response to the one or more AI models corresponding to the DMRS pattern being a plurality of AI models, the configuration information being for instructing the UE to select one AI model matching one of a moving speed of the UE, channel quality, computational capability of the UE, and storage capability of the UE from the plurality of AI models to perform the channel estimation.

15. The information processing method according to claim 13, wherein the configuration information further comprises at least one of: the DMRS pattern, and
the configuration information is for instructing the UE whether to use the AI models corresponding to the DMRS pattern to perform channel estimation;
AI indication information for indicating whether to enable the AI model to perform channel estimation, and
in response to the AI indication information indicating to enable the AI model to perform channel estimation, the AI indication information is for instructing the UE to use the AI model corresponding to the DMRS pattern to perform channel estimation;
AI model indication information for instructing the UE to select the AI model to perform channel estimation from the AI models corresponding to the DMRS pattern.

16-17. (canceled)

18. The information processing method according to claim 15, further comprising:
in response to determining that there is no AI model corresponding to the DMRS pattern in the UE, sending model information of at least one of the one or more AI models corresponding to the DMRS pattern.

19. The information processing method according to any one of claim 15, comprising:
receiving second recommended information; and
determining the configuration information based on the DMRS pattern recommended for use by the UE and indicated by the second recommended information.

20. An information processing method, performed by a base station, the information processing method comprising:
receiving first recommended information; wherein the first recommended information indicates a demodulation reference signal (DMRS) pattern used by a user equipment (UE), or the first recommended information indicates the DMRS pattern used by the UE and an artificial intelligence (AI) model required by the UE; wherein the AI model is for the UE to perform channel estimation;
determining, based on the first recommended information, model information of the AI model corresponding to the DMRS pattern required by the UE; and
sending the model information.

21-40. (canceled)

41. A communication device, comprising:
a processor; and
a memory for storing executable instructions for the processor;
wherein the processor is configured to execute the executable instructions to implement the information processing method according to claim 1.

42. A non-transitory computer storage medium having a computer executable program stored thereon, wherein the executable program is executed by a processor to implement the information processing method according to claim 1.
